(19) United States
(12) Patent Application Publication
(10) Pub. No.: US 2016/0363457 A1
(43) Pub. Date: Dec. 15, 2016

(54) METHOD AND APPARATUS FOR DISPATCHING NETWORK EQUIPMENT WITHIN A COMMUNICATION SYSTEM

(71) Applicant: MOTOROLA SOLUTIONS, INC, SCHAUMBURG, IL (US)

(72) Inventors: STANKO JELAVIC, DAVIE, FL (US); MIRCEA CAPOTA, BOCA RATON, FL (US); DANIEL A TEALDI, PLANTATION, FL (US)

(21) Appl. No.: 14/735,599

(22) Filed: Jun. 10, 2015

(51) Int. Cl. G01C 21/36; H04W 4/04; H04W 16/04; H04B 7/185; H04W 4/22

(52) U.S. Cl. CPC G01C 21/36; H04B 7/18504; H04W 4/22; H04W 16/04; H04W 4/046; H04W 88/08

(57) ABSTRACT

In order to improve radio-frequency (RF) coverage along a route to/from an incident, a method and apparatus for autonomous dispatching of network equipment is provided herein. During operation, a route to/from an incident scene will be determined. RF coverage, and or the load level of the equipment along the route will be determined, and a determination whether or not adequate coverage/capacity will be provided to vehicles along the route is made. A base station will be dispatched along the route based on a determination if equate coverage/capacity will be provided to vehicles traveling along the route.

### FIELD OF THE INVENTION

The present invention generally relates to dispatching network equipment, and in particular to dispatching network equipment based on a predicted route of public-safety vehicle(s) within a communication system.

### BACKGROUND OF THE INVENTION

Oftentimes a public-safety incident will over tax any communications network equipment handling an incident. For example, due to a large number of public-safety vehicles and personnel at, for example, a large fire, a base station(s) handling wireless communications may be overloaded. In order to solve this issue, it has been proposed to provide mobile base stations at the incident scene in order to aide communications. For example, WO2015/021159 A1, entitled SYSTEM AND METHOD FOR IMPLEMENTING AN AIRBORNE TELECOMMUNICATION NETWORK USING AN UNMANNED AERIAL VEHICLE, (incorporated by reference herein), provides for a drone to aide in restoring telecommunications in areas otherwise isolated by a disaster.

While deploying mobile base stations will improve coverage at an incident scene, in many instances coverage along routes to and from the incident scene are also taxed because of the added burden of many public-safety vehicles traveling the same route. In addition, a particular route used by public-safety vehicles may pass through a “coverage hole”, where inadequate network coverage exists. Therefore, a need exists for a method and apparatus for dispatching network equipment in order to alleviate poor network coverage along a route to and from an incident scene.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a general operational environment at an incident scene.

FIG. 2 illustrates a simplified map used to aide in understanding the operation of the present invention.

FIG. 3 illustrates a simplified map used to aide in understanding the operation of the present invention.

FIG. 4 is a block diagram of the dispatch center of FIG. 1.

FIG. 5 is a flow chart showing operation of the dispatch center of FIG. 3.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to improve radio-frequency (RF) coverage along a route to/from an incident, a method and apparatus for dispatching network equipment is provided herein. During operation, a route to/from an incident scene will be determined. RF coverage along the route will be determined, and a determination whether or not adequate coverage will be provided to vehicles along the route is made. Network equipment will be dispatched along the route based on a determination if equate coverage will be provided to vehicles traveling along the route.

It should be noted that in a first embodiment of the present invention, network equipment comprises a base transceiver station (BTS) connected wirelessly to existing communication system infrastructure. A BTS is generally considered an “intelligent” terminal, as it has the processing and control capability to influence a substantial amount of the communication traffic passing through it. In a further embodiment of the present invention, network equipment comprises a radio repeater station, which performs a minimal amount of processing in receiving a communication and re-transmitting the received communication along the wireless communication path. As a repeater station has little control over the communication passing through it, it is often termed a “dummy” terminal. For ease of understanding, the following description is provided describing a base station being deployed; however, one of ordinary skill in the art will recognize that any network equipment may be deployed as described herein without varying from the scope of the invention.

Network equipment will be dispatched when needed, via a mobile platform, such as, but not limited to, a cell on wheels (COW), a snowmobile, a drone, an aircraft, a balloon, or any other means for deploying network equipment to provide coverage to a determined route.

In one embodiment of the present invention, a determination of whether or not adequate coverage exists along a route is determined by determining a current base station load for base stations providing coverage along the route, and estimating whether or not the increased number of vehicles traveling along the route will over tax any of these base stations.

In alternate embodiments, a simpler technique may be utilized to determine if base stations along a route will provide adequate coverage. For example, adequate RF coverage along a route may be determined by utilizing stored “coverage maps” showing good and poor RF coverage for a particular area. Areas with acceptable RF coverage are capable of handling traffic from vehicles traveling along the route, while areas with poor RF coverage will be incapable of handling an increase in traffic due to many public-safety vehicles being dispatched along the route.

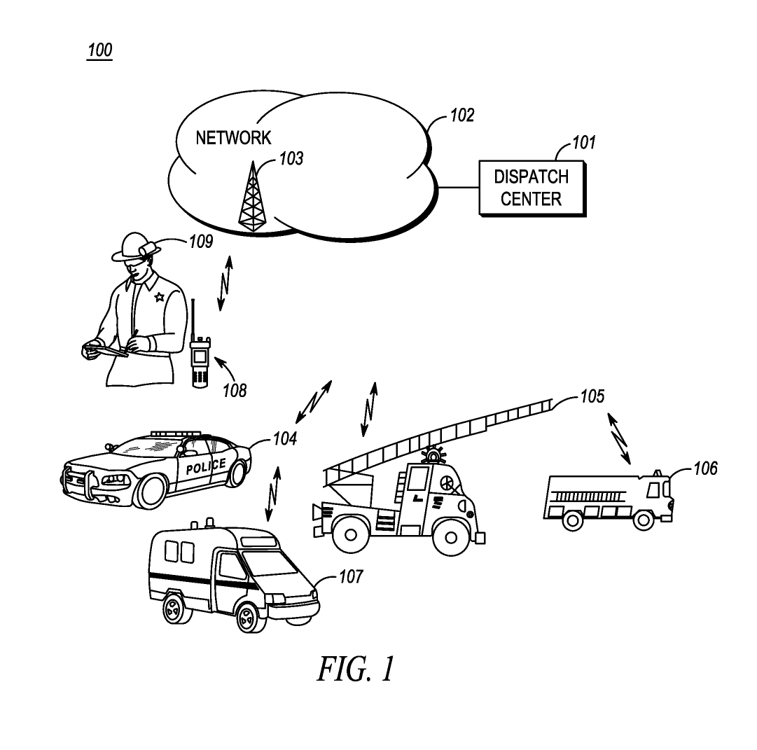

Turning now to the drawings wherein like numerals designate like components, FIG. 1 is a block diagram showing a general operational environment of communication system 100, according to one embodiment of the present invention. As shown in FIG. 1 a plurality of public-safety vehicles 104-107 and devices 108 are in communication with dispatch center 101 (serving as vehicle geographic router 101) through base station 103 and intervening network 102.

Public-safety vehicles 104-107 may comprise such vehicles as rescue vehicles, ladder trucks, ambulances, police cars, fire engines, . . . , etc. While devices 108 (only one shown) can be any portable electronic device including but not limited to a standalone display or monitor, a handheld computer, a tablet computer, a mobile phone, a police radio, a media player, a personal digital assistant (PDA), a GPS receiver, or the like, including a combination of two or more of these items.

Network 102 may comprise one of any number of over-the-air or wired networks. For example network 102 may comprise a private 802.11 network set up by a building operator, a next-generation cellular communications network operated by a cellular service provider, or any public-safety network such as an APCO 25 network. Network 102 usually comprises several base stations and/or repeater stations 103 (only one shown). Base stations 103 can receive information (either control or media, e.g., data, voice (audio), video, etc.) in a signal from vehicles 104-107 and devices 108. Base stations 103 can also transmit information in signals to one or more vehicles 104-107 and devices 108. Base stations 103 have a finite capacity, that when reached, limit the base station from providing coverage to public-safety vehicles.

In this particular illustration the functionality of a vehicle geographic router exists within dispatch center 101, although in alternate embodiments of the present invention this functionality may be located as stand-alone equipment, or alternatively in any network entity. Additionally, although only four public-safety vehicles 104-107 are shown, one of ordinary skill in the art will recognize that any number of vehicles may be geographically routed to a particular incident. Similarly, although only one device 108 is shown in FIG. 1, one of ordinary skill in the art will recognize that many more devices may be routed to any particular incident scene.

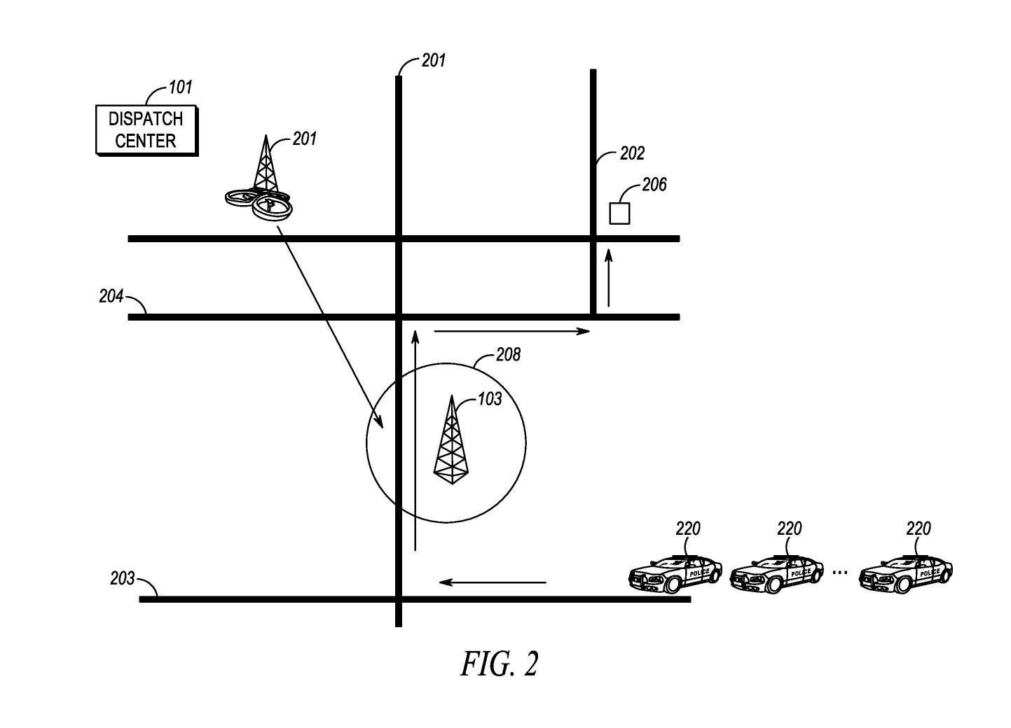

As discussed above, oftentimes a public-safety incident will over tax network equipment along the route to/from the incident. For example, due to a large number of public-safety vehicles and personnel dispatched to, for example, a large fire, base station 103 handling the wireless communications to vehicles along the route to/from the fire may be overloaded. (It should be noted that although the term “base station” is used herein, any overburdened network equipment may be overloaded, and aided in a similar manner as described below). In order to address this issue, portable base stations will be placed along the route where needed. This is illustrated in FIG. 2.

FIG. 2 illustrates a simplified map used to aide in understanding the operation of the present invention. In this particular example, current base station capacity is being used to determine potential coverage needs along a route, however one of ordinary skill in the art will recognize that any technique used to determine a coverage need will suffice.

With reference to FIG. 2, assume that base station 103 is currently loaded above a predetermined threshold (e.g., 85% of capacity) and many vehicles 220 will need to be routed through its coverage area, due for example, to vehicles 220 being routed to an incident within building 206. (e.g., geographic route that takes vehicles 220 down road 203 to road 204 would require vehicles 220 to pass through coverage area 208 of base station 103). Because of this, dispatch center 101 may predict that base station 103 will not have enough capacity to handle the traffic along the route, and will dispatch a portable base station near base station 103 in order to aide base station 103 in providing coverage to public-safety vehicles 220. This is illustrated in FIG. 2, with added base site 201 being dispatched accordingly.

It should be noted that the routing of vehicles 220 will preferably take place by dispatch center 101 providing the geographic route to vehicles 220 via over-the-air communication using network 102. Vehicles 220 may be “unaware” of any RF load issues with base station 103. It should also be noted that any dispatched base station will “aide” an existing base station, meaning that the existing base station will continue to operate at a lower load level. For example, the deployed base station may aide existing base stations as described in US Pub. No. 2014/0348083, METHODS OF INCORPORATING AN AD-HOC CELLULAR NETWORK INTO A FIXED CELLULAR NETWORK, incorporated by reference herein.

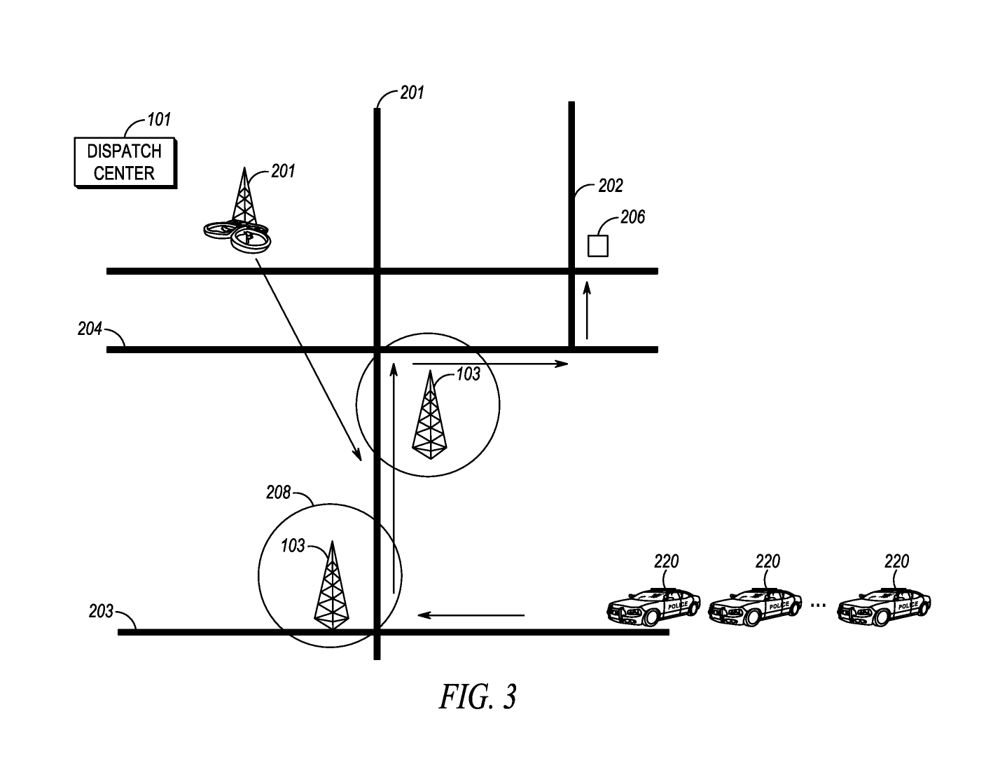

FIG. 3 illustrates a simplified map used to aide in understanding the operation of the present invention in accordance with another embodiment. In this particular embodiment, coverage maps are utilized by dispatch center 101 to aide in placement of network equipment 201. More particularly, after a route is determined for vehicles 220 (it should be noted that all vehicles may not share the same route due to their differing starting locations), dispatch center 101 utilizes stored coverage maps to determine if there exists a coverage hole along the route. In this particular example, a coverage hole exists between base stations 103, and network equipment 201 is dispatched accordingly to provide coverage to the hole.

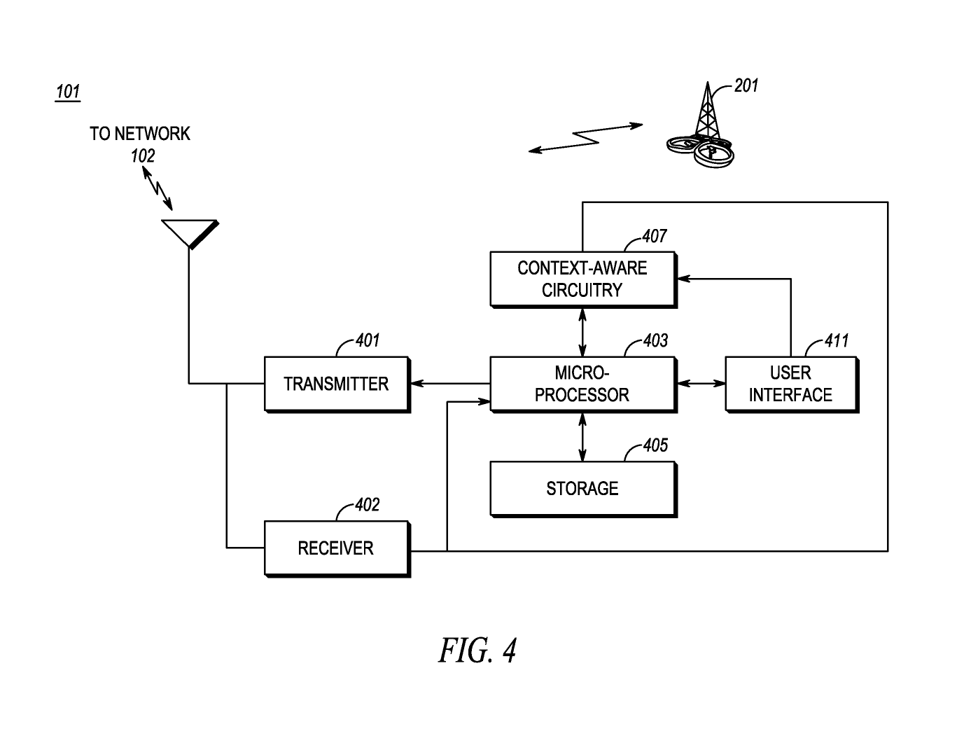

FIG. 4 is a block diagram of dispatch center 101. Dispatch center 101 typically comprises processor 403 (sometimes referred to as a microprocessor, logic unit, or logic circuitry) that is communicatively coupled with various system components, including transmitter 401, receiver 402, general storage component (database) 405, context-aware circuitry 407, and user interface (GUI) 411. Only a limited number of system elements are shown for ease of illustration; but additional such elements may be included in the dispatch center 101.

Processing device 403 may be partially implemented in hardware and, thereby, programmed with software or firmware logic or code for performing functionality described herein; and/or the processing device 403 may be completely implemented in hardware, for example, as a state machine or ASIC (application specific integrated circuit). Storage 405 can include short-term and/or long-term storage of various information needed for the recall of specific knowledge to aide in routing vehicles and for routing portable network equipment. For example, storage 405 may comprise street maps, coverage maps, vehicle locations, current locations of incidents, base station loading levels, routes for various vehicles, etc. Storage 405 may further store software or firmware for programming the processing device 403 with the logic or code needed to perform its functionality.

User interface 411 receives an input from a user that may be used to geographic route vehicles accordingly. For example, user interface 411 provides a way of inputting a type of emergency event along with an address of the emergency event. In an embodiment, event information may be displayed to the user of dispatch center 101 along with vehicles dispatched. In order to provide the above features (and additional features), user interface 411 may include a keypad, a display/monitor, a mouse/pointing means, and/or various other hardware components to provide a man/machine interface.

Context-aware circuitry 407 preferably comprises circuitry that determines traffic conditions. For example, context-aware circuitry 407 may comprise a receiver or network interface that receives current traffic conditions from a subscribed service, for example, Google™ Maps. Circuitry 407 also receives base stations RF load levels. The coverage areas and RF load levels may be retrieved from storage 405 or received in real time via receiver 402, or a combination of both. Logic circuitry 403 will use information generated by circuitry 407 and retrieved from storage 405 to determine appropriate geographic routes for any person or vehicle.

Transmitter 401 and receiver 402 are common circuitry known in the art for communication utilizing a well known communication protocol, and serve as means for transmitting and receiving messages. For example, receiver 402 and transmitter 401 may be well known long-range transceivers that utilize the Apco 25 (Project 25) communication system protocol. Other possible transmitters and receivers include, IEEE 802.11 communication system protocol, transceivers utilizing Bluetooth, HyperLAN protocols, or any other communication system protocol.

In a preferred embodiment processor 403 is configured to receive a notification that vehicle(s) needs to be geographic routed to a particular location/destination. (Note that the notification may be part of an automated process and need not be input to logic circuitry 403 via user interface 411). The vehicle(s) location(s) is determined. This determination may be made by processor 403 receiving an updated location from the vehicle(s) through receiver 402, or by accessing database 405 to determine stored locations for vehicles.

Once the location/destination and the current vehicle(s) location(s) are known, processor 403 is configured to determine an appropriate geographic route(s) for the vehicle (note that the routes may be different for different vehicles). More particularly, a map is obtained from storage 405, and a shortest route (in time and/or distance) is determined (which may be determined based on current traffic conditions). In one embodiment, RF load levels for base stations within network 102 are also determined, and a predicted load levels for the base stations is obtained based on how many vehicles will be routed through a particular base station's coverage area. The load levels may be periodically provided by base stations within the system and stored in storage 405. In another embodiment, a coverage map is retrieved by processor 403 from storage 405 and used to determine if any RF coverage holes exist along the route(s).

Calculation of Where to Dispatch Portable Network Equipment:

Geographic routes will be calculated for each responding person/vehicle within a single or distributed networked server. As an example, the server functionality is included within dispatch center 101, and in particular, within processor 403. Once a vehicle or person needs to be dispatched to a particular area, the following information will be obtained by processor 403:
A destination: This information may be automatically obtained via a 911 computer-aided dispatch system, or provided to circuitry 407 via user interface 411. The destination may be a location of a public-safety incident, or alternatively may simply be a location where a patrol is desired.
A current location of person or vehicle to be dispatched: Receiver 402 will periodically receive the locations for all persons or vehicles that may be dispatched. This information is normally obtained via standard messaging between devices/vehicles and dispatch center 101. This information may be stored in storage 405 until it is again periodically updated. Context-aware circuitry will use this information in determining routes to an incident scene.
Traffic conditions for all possible geographic routes to the destination from the current location (optional). In order to aide in determining a more-efficient geographic route, it may be necessary to determine traffic conditions so that heavily-congested geographic routes may be avoided. This is accomplished ideally via context-aware circuitry 407 receiving this information from a subscribed source (not shown in FIG. 4), such as Google Maps®.
Coverage areas or coverage holes for/between each base station within the network (one embodiment of the present invention): Because this information rarely changes, this information is preferably pre-populated within storage 405. Processor 403 may use this information in determining where to dispatch network equipment.
Current RF load for each base station within the network (another embodiment of the present invention): This information may be transmitted wirelessly by each base station, or may be backhauled to the dispatch center from each base station. Regardless of how this information is received, the information is received and stored in storage 405. Processor 403 may use this information in determining where to dispatch network equipment.

With the above information known, circuitry 407 can calculate an appropriate geographic route for all vehicles responding to the particular incident. Once these routes are known and provided to processor 403, a prediction may be may be made by processor 403 as to whether or not adequate coverage exists along these routes. As discussed, it may be determined if any base station along the route(s) will be over taxed by determining a current load (e.g., 80%) and a predicted future load from all vehicles being routed through a particular base station. It may be determined whether or not any base station along the route may be operating at over 90% capacity due to a number of vehicles being simultaneously within the coverage area of a particular base station. If this is the case, logic circuitry 403 will provide coordinates for dispatching of additional network equipment in order to reduce a load on any over-taxed base station.

Alternatively, processor 403 may be configured to determine if any vehicle's route passes through a coverage hole, and if so logic circuitry 403 will provide coordinates for dispatching of additional network equipment in order to reduce a load on any over-taxed base station.

In FIG. 4, network equipment to be dispatched is shown as drone/base station combination 201. Coordinates for deployment may be provided by logic circuitry 403 to drone/BTS 201 via an interface (wired or wireless). In a preferred embodiment, the coordinates are provided via transmitter 401 to drone/base station combination 201. The coordinates may be determined to be a particular geographical location and or area in combination with the elevation and recommended transmit power for the base/repeater. By placing the base/repeater at that recommended location will significantly improve the coverage in that area based on the calculations done by the logic circuitry 403.

It should be noted that the drone may simply drop off a base station at the particular coordinates provided by logic circuitry 403, may hover at the particular location, or may land and remain attached to the base station while deployed. Regardless of the technique used to “deploy” network equipment, drone/BTS combination 201 will be configured to provide coverage to vehicles along a route to an incident.

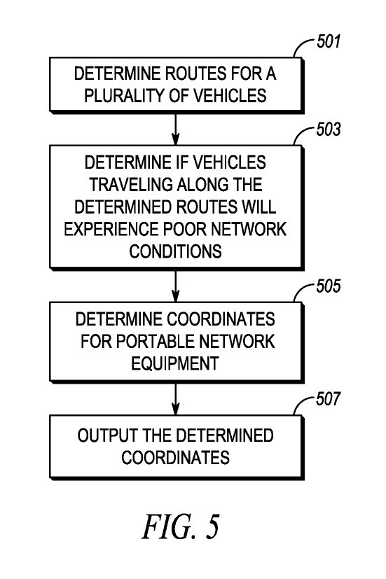

FIG. 5 is a flow chart showing operation of dispatch center 101. The logic flow begins at step 501 where processor 403 determines routes for a plurality of vehicles. As discussed above, these routes may be determined based on current traffic conditions received from context-aware circuitry 407, and the plurality of vehicles may comprise a plurality of public-safety vehicles dispatched to a public-safety incident.

At step 503 processor 403 determines if vehicles traveling along the determined routes will experience poor network conditions. As discussed above, the poor network conditions comprise a radio frequency (RF) coverage hole and/or network equipment having a load level above a predetermined threshold.

At step 505 processor 403 determines coordinates for portable network equipment based on whether or not the vehicles traveling along the routes will experience the poor network conditions. Finally, the logic flow continues to step 507 where processor 403 outputs the determined coordinates to the portable network equipment through transmitter 401. As discussed above, the portable network equipment may comprise a drone/base station combination or a drone/repeater combination.

Although not mentioned in the logic flow above, an added step of determining a desired elevation and power level for the drone/base station combination and outputting the desired elevation and power level to the drone/base station combination may be incorporated into the logic flow.

The above logic flow results in an apparatus for dispatching network equipment. The apparatus comprises a processor configured to determine routes for a plurality of vehicles, determine if vehicles traveling along the determined routes will experience poor network conditions, and to determine coordinates for portable network equipment based on whether or not the vehicles traveling along the routes will experience the poor network conditions. A interface (e.g., a transmitter) is coupled to the processor for outputting the determined coordinates to the portable network equipment.

As discussed, the poor network conditions comprise a radio frequency (RF) coverage hole and/or network equipment having a load level above a predetermined threshold. Additionally, the apparatus may comprise context-aware circuitry configured to receive traffic conditions, and the processor utilizes the traffic conditions to determine the routes for the plurality of vehicles.

As discussed above, the plurality of vehicles may comprise a plurality of public safety vehicles dispatched to a public-safety incident and the portable network equipment may comprise a drone/base station combination.

In the foregoing specification, specific embodiments have been described. However, one of ordinary skill in the art appreciates that various modifications and changes can be made without departing from the scope of the invention as set forth in the claims below. For example, although the above examples were given with a vehicle being geographic routed accordingly, in alternate embodiments of the present invention a person may be geographic routed in a similar fashion. It should also be noted that a load level at a base station may encompass a load level at any RF site (e.g., a sector of a base station). Load levels can also encompass a number of channels in use, so for example, at a 10-channel site, if 9 channels are in use, then a single channel is available for use, and the load will be 90%. In addition, although the above description was given with respect to routing vehicles to an incident scene, one of ordinary skill in the art will recognize that the above concept may be utilized in non-emergency situation. For example, the above technique may be utilized to determine routes for non-emergency vehicles, to, or example, a sporting event, and determine if any network equipment will be over taxed. Accordingly, the specification and figures are to be regarded in an illustrative rather than a restrictive sense, and all such modifications are intended to be included within the scope of present teachings.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An apparatus for autonomous dispatching of network equipment, the apparatus comprising:
a processor configured to determine routes for a plurality of vehicles, determine if vehicles traveling along the determined routes will experience poor network conditions, the processor additionally configured to determine coordinates for portable network equipment based on whether or not the vehicles traveling along the routes will experience the poor network conditions; and
an interface coupled to the processor for outputting the determined coordinates to the portable network equipment.

2. The apparatus of claim 1 wherein the poor network conditions comprise a radio frequency (RF) coverage hole and/or network equipment having a load level above a predetermined threshold.

3. The apparatus of claim 2 further comprising context-aware circuitry configured to receive traffic conditions, and wherein the processor utilizes the traffic conditions plus the starting point and destination point coordinates and start time and destination projected time to determine the routes for the plurality of vehicles.

4. The apparatus of claim 3 wherein the plurality of vehicles comprise a plurality of public safety vehicles dispatched to a public-safety incident.

5. The apparatus of claim 4 wherein the portable network equipment comprises a drone/base station combination.

6. The apparatus of claim 5 wherein the processor is additionally configured to determine a desired elevation and power level for the drone/base station combination and output the desired elevation and power level to the drone/base station combination.

7. A method for dispatching network equipment, the method comprising the steps of:
determining via a processor, routes for a plurality of vehicles;
determining via the processor, if vehicles traveling along the determined routes will experience poor network conditions;
determining via the processor, coordinates for portable network equipment based on whether or not the vehicles traveling along the routes will experience the poor network conditions; and
outputting the determined coordinates to the portable network equipment.

8. The method of claim 7 wherein the poor network conditions comprise a radio frequency (RF) coverage hole and/or network equipment having a load level above a predetermined threshold.

9. The method of claim 8 further comprising the step of receiving traffic conditions, and wherein the step of determining the routes is further based on the traffic conditions.

10. The method of claim 9 wherein the plurality of vehicles comprise a plurality of public-safety vehicles dispatched to a public-safety incident.

11. The method of claim 10 wherein the portable network equipment comprises a drone/base station combination.

12. The method of claim 11 further comprising the steps of determining a desired elevation and power level for the drone/base station combination and outputting the desired elevation and power level to the drone/base station combination.
